(19) United States
(12) Patent Application Publication
(10) Pub. No.: US 2017/0091079 A1
(43) Pub. Date: Mar. 30, 2017

(54) PERFORMANCE TESTING SYSTEM AND METHOD

(71) Applicant: Kai Zhou, Thornhill (CA)

(72) Inventor: Kai Zhou, Thornhill (CA)

(21) Appl. No.: 15/311,845

(22) PCT Filed: May 19, 2015
(86) PCT No.: PCT/CA2015/050445

§ 371 Date: Nov. 16, 2016

Related U.S. Application Data
(60) Provisional application No. 61/994,947, filed on May 18, 2014.

(51) Int. Cl. G06F 11/36; G06F 11/34

(52) U.S. Cl. CPC G06F 11/3672; G06F 11/3433; G06F 11/3419; G06F 2201/87

(57) ABSTRACT

Performance testing systems, computer-implemented methods of performance testing, and non-transitory computer-readable media embodying computer programs for performance testing are described. In one embodiment, a performance testing system includes processing structure configured to execute performance testing, the performance testing comprising automatically and repeatedly initiating concurrent test sessions with at least one performance test target during a test period, the processing structure configured to receive test modification requests during the test period and, in response, to automatically modify the performance testing for the remainder of the test period.

### CROSS-REFERENCE TO RELATED APPLICATION

This application claims priority under 35 U.S.C. 119(e) from U.S. Provisional Patent Application Ser. No. 61/994,947 filed on May 18, 2014.

### FIELD OF THE INVENTION

The following relates generally to software testing, and more particularly to systems and methods for performance testing.

### BACKGROUND OF THE INVENTION

Conventional performance test tools usually run performance test with static conditions such as the number of concurrent users, scenario that is being tested, as well as the execution sequence of different scenarios. These tools are not efficient for performance problem analysis, as testers may have to run the test many times with modified test conditions to produce different test results for comparison to find impacts caused by condition change These tools also are not able to perform over-all validation of the system being tested as they don't perform the test in real-world like scenario randomness and concurrency.

### SUMMARY OF THE INVENTION

In accordance with an aspect, there is provided a performance testing system comprising processing structure configured to execute performance testing, the performance testing comprising automatically and repeatedly initiating concurrent test sessions for different scenarios in a random sequence with at least one performance test target during a test period, the processing structure configured to receive test modifications during the test period and, in response, to automatically modify the performance testing for the remainder of the test period.

In accordance with another aspect, there is provided a computer-implemented method for performance testing comprising: using the computer, executing performance testing comprising automatically and repeatedly initiating concurrent test sessions for different scenarios in a random sequence with at least one performance test target during a test period; and using the computer, receiving test modifications during the test period and, in response, automatically modifying the performance testing for the remainder of the test period.

In accordance with another aspect, there is provided a non-transitory computer-readable medium embodying a computer program executable on a computing system for conducting performance testing, the computer program comprising computer program code for executing performance testing comprising automatically and repeatedly initiating concurrent test sessions for different scenarios in a random sequence with at least one performance test target during a test period; and computer program code for receiving test modifications during the test period and, in response, automatically modifying the performance testing for the remainder of the test period.

Due to the improvements of the systems and methods provided herein, modifications to a performance test being run can be made any number of times during the test period, while the performance test is being run and without having to stop the performance testing to implement or re-program the modifications. The ability to dynamically adjust test parameters such as the course of performance testing and the performance testing intensity in this way is very useful for facilitating root cause analysis of a performance issue. A performance tester is able to use the performance testing system to repeatedly react and interact with the system during the actual performance testing based on what how it has been going until that point.

In accordance with another aspect, there is provided a performance testing system comprising processing structure configured to execute performance testing, the performance testing comprising automatically and repeatedly initiating concurrent test sessions with at least one performance test target during a test period, the processing structure configured to receive requests during the test period for live reports of selected one or more subsets of live statistics about the test sessions and, in response, to automatically display the live reports during the test period.

In accordance with another aspect, there is provided a computer-implemented method for performance testing comprising: using the computer, executing performance testing comprising automatically and repeatedly initiating concurrent test sessions with at least one performance test target during a test period; and using the computer, receiving requests during the test period for live reports of selected one or more subsets of live statistics about the test sessions and, in response, automatically displaying the live reports during the test period.

In accordance with another aspect, there is provided a non-transitory computer-readable medium embodying a computer program executable on a computing system for conducting performance testing, the computer program comprising: computer program code for executing performance testing comprising automatically and repeatedly initiating concurrent test sessions with at least one performance test target during a test period; and computer program code for receiving requests during the test period for live reports of selected one or more subsets of live statistics about the test sessions and, in response, automatically displaying the live reports during the test period.

Due to the improvements of the systems and methods provided herein, request for the display of various live statistics can be made any number of times during the test period, while the performance test is being run and without having to stop the performance testing to implement or re-program the modifications. The ability to dynamically adjust reports parameters such as which performance testing target is being reported on (by machine, by interface/socket, by protocol for examples), the nature of the statistics/metrics being reported (such as CPU cycles of a performance testing target, or latency, or memory usage), the granularity of the reporting (such as variations over seconds or minutes) in this way is very useful for facilitating root cause analysis of a performance issue. A performance tester is able to use the performance testing system to repeatedly react and interact with the system on the basis of on-demand reporting/charting during the actual performance testing based on what how it has been going until that point.

A combination of enabling both test modifications and reports requests during the test period provides a very rich set of tools for enabling the performance tester to immediately have feedback about the metrics he or she is looking for and how they are affected by particular modifications that he or she is able to dynamically make during the performance testing itself This in turn informs the performance tester about what he or she may wish to modify in order to re-focus the performance testing or to perform verifications of an initial indication.

Other aspects will be apparent from the description set forth below.

### BRIEF DESCRIPTION OF THE DRAWINGS

Embodiments of the invention will now be described with reference to the appended drawings in which:

FIG. 1 is a flowchart depicting steps in a computer-implemented method of performance testing;

FIG. 2 is a block diagram showing components of a computing system that may be configured to execute the performance testing, and performance testing targets;

FIG. 3 is a screenshot of a user interface produced by the performance testing system for initiating and controlling the parameters of the performance testing and for displaying live statistics during a test period; and

FIG. 4 is a logical structure diagram showing logical components of the performance testing system.

### DETAILED DESCRIPTION

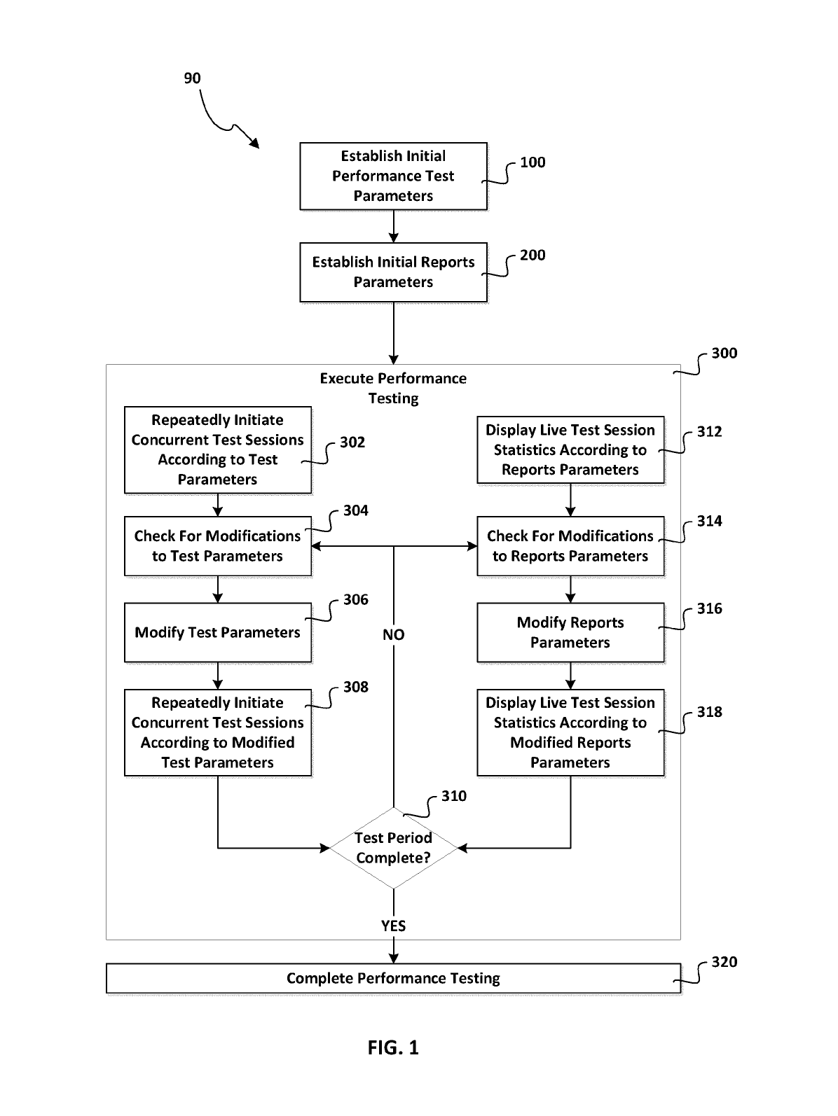

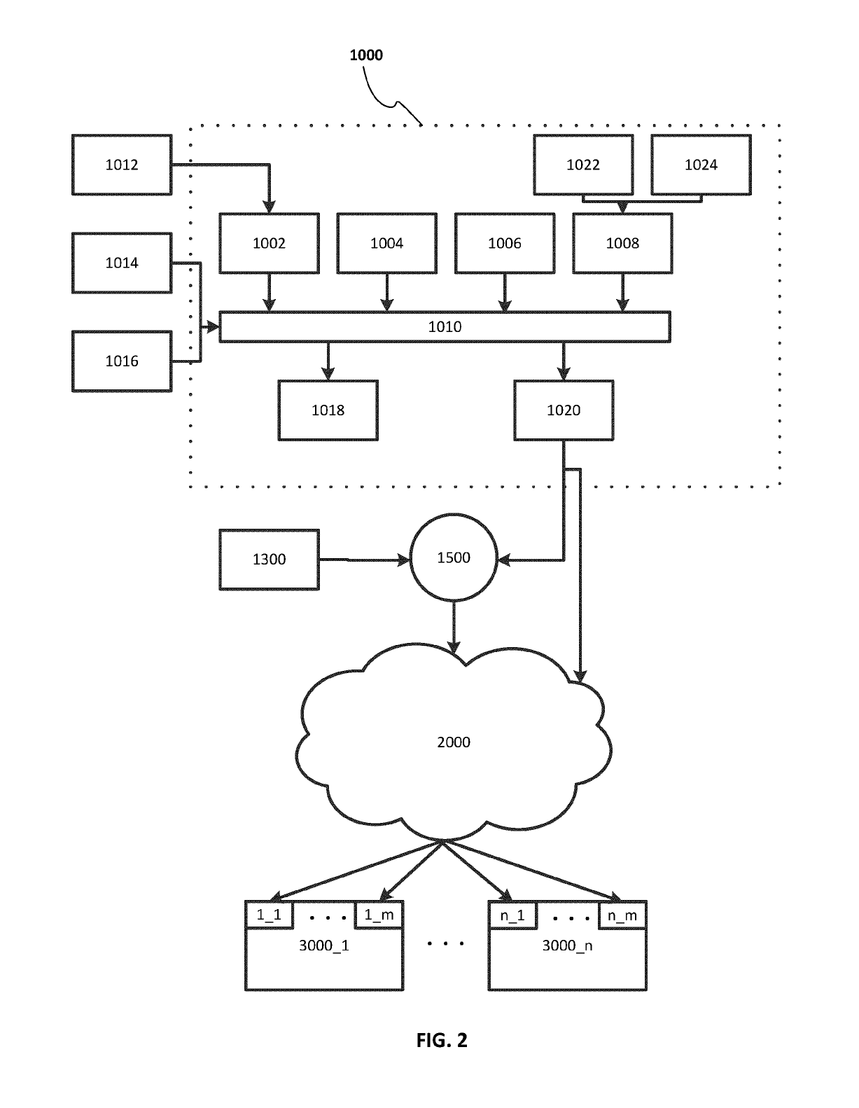

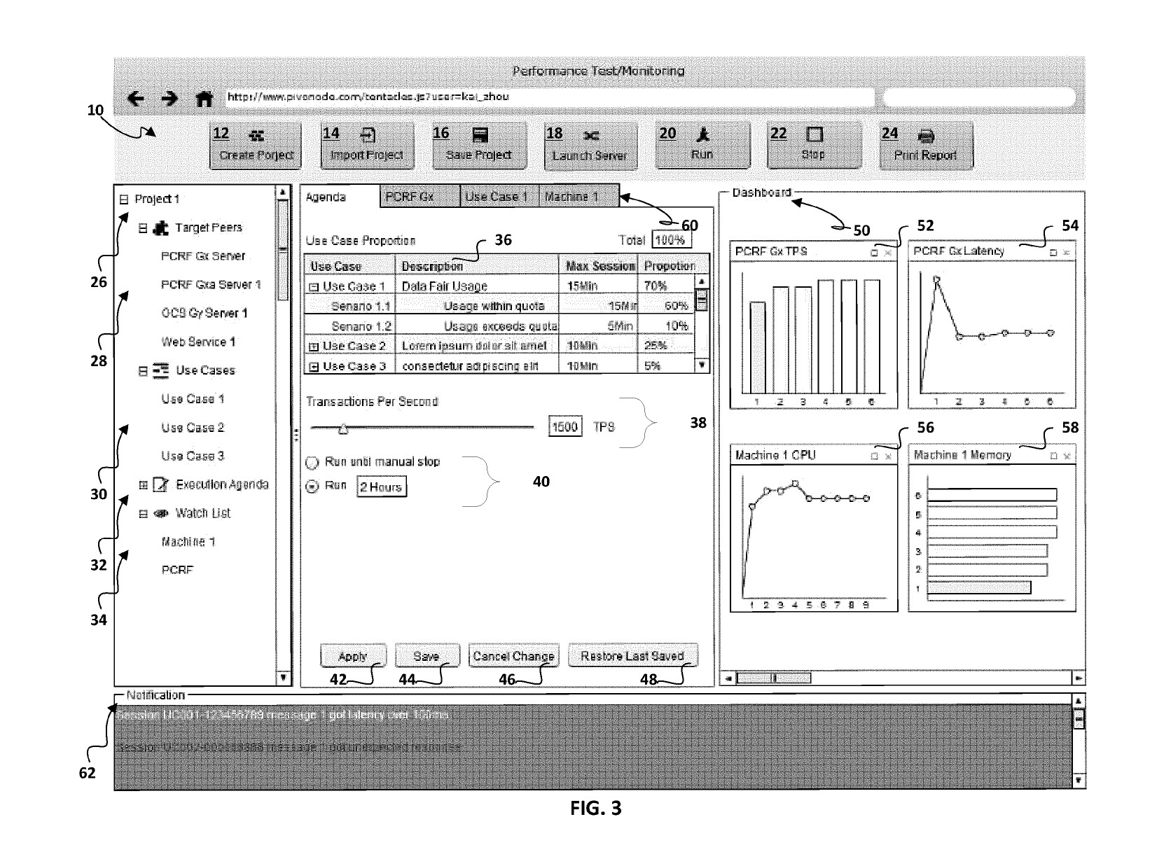

FIG. 1 is a flowchart depicting steps in a computer-implemented method 90 of performance testing, that may be implemented by a computing system 1000 as shown in FIG. 2 and as described in detail below. During the method 90, initial performance test parameters are established (step 100), and initial reports parameters are established (step 200). Steps 100 and 200 may be done by a user via a user interface 10 such as that shown in the screenshot of FIG. 3. It will be understood that, as will be described, the performance testing system implemented by computing system 1000 may be operated simultaneously via multiple user interfaces similar to user interface 10, by different users running different performance tests on different performance test targets.

For example, upon initial setup, the user may create a project 26 by clicking the Create Project button 12, and then specify test parameters such as the “Target Peers” 28 (for each of which the specification may include host name, IP address, port number, protocol name etc), the Use Cases 30 to be tested, the Scenarios making up each of the Use Cases 30, the number of transactions per second (TPS) 38 to be initiated by the performance testing system during the test period, the duration 40 of the test period, and the proportion of transactions 36 to be allocated to each of the Use Cases 30. A set of tabs 60 is provided for enabling a user to view information about particular Use Cases 30, Target Peers 28 and the like.

As an alternative to creating a project using the Create Project button 12, the user may import a previously-defined project using the Import Project button 14. Any adjustments to the currently-active project, whether it has been newly created or imported, may be saved by pressing the Save Project button 16.

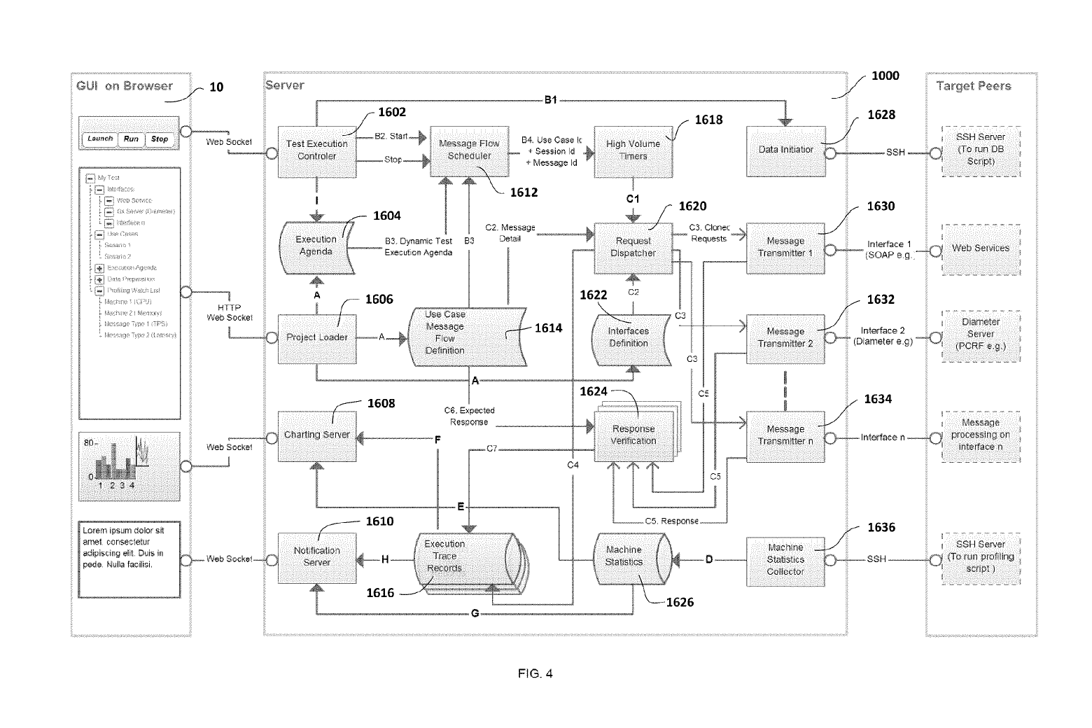

In this embodiment, as shown in FIG. 4, a performance test has been set up for testing a system that include four (4) different interfaces (Target Peers), named “PCRF Gx Server”, “PCRF Gxa Server 1”, “OCS Gy Server 1” and “Web Service 1”. Furthermore, the information of machines involved in the tested system can be extracted out of specification of Target Peers, for example, “PCRF Gx Server” can be hosted on “Machine 1”, while others may be hosted on same or different machines respectively.

Also in this embodiment, three (3) Use Cases 30 have been established, and the Use Case Proportion (involved use cases) 36 displayed in the table in the middle section of the user interface shows that the number of sessions configured to be used for Use Case 1 will take up 70% of all sessions during the test period, with 60% devoted to Scenario 1.1 of Use Case 1 and 10% devoted to Scenario 1.2 of Use Case 1. The number of sessions configured to be used for Use Case 2 will take up 25% of all sessions during the test period, and the number of sessions configured to be used for Use Case 3 will take up the remaining 5% of all sessions during the test period.

The test parameters for the project 26 in this embodiment further establish an Execution Agenda 32, that 1500 transactions per second (TPS) will be handled, and the performance test once started using the Run button 20 will last for two (2) hours. As such, in this project 26 as initially configured, a total of 1500×(60 seconds/minute)×(60 minutes/hour)×(2 hours)=10,800,000 transactions are to be handled during the test period.

Prior to or during running the performance test, the user may also specify a “Watch List” 34 of live reports of statistics to be provided to the user interface 10 for display by the user interface 10. In this embodiment, the user has chosen to add to the Watch List 30 for display on a Dashboard section 50 of the user interface 10 at least: a graph of the TPS (Transactions Per Second) on Target Peer “PCRF Gx Server” 52, the Latency (response time) on Target Peer “PCRF Gx Server” 54, the CPU usage of Machine 1 56, and the Machine 1's Memory Usage 58, while “Machine 1” is a machine that hosts one of the Target Peers and its specification can be combined with that of Target Peers.

Any changes made to Use Case Proportion (involved use cases) 36, TPS 38, Watch List 34 either prior to or during a performance test made be Applied using the Apply button 44 (applied during the test run, the remainder of the test will automatically run in the new condition), saved to the project 26 using the Save button 44, cancelled using the Cancel Change button 46, or restored using the Restore Last Saved button 48. A Notification section 62 displays particular notifications that the user interface program has received from the server side of the performance testing system.

In this embodiment, the project that may be imported or saved including Target Peers 28 specification, Use Cases 30 specification, Agenda 32 (initial Use case Proportion 36, initial TPS) and initial Watch List 34 for charting, are stored in a structured format such as XML (eXtensible Markup Language) in a data store as will be described.

With the initial test and reports parameters (Agenda 32, Watch List 34) having been established at steps 100 and 200, the performance testing may be executed (step 300). In this embodiment, this may be done by a user first checking that the performance testing service has been launched by pressing the Launch Server button 18, and then pressing the Run button 20 in the user interface 10. At any time, the user may stop the performance testing by pressing the Stop button 22. However, as described herein, the user does not have to press the Stop button 22 in order to make modifications to the performance testing nor to change the live statistics being charted and displayed in the user interface 10. A Print Report button 24 is provided in the user interface 10 in order to enable a user to print a report of the performance test for the use of a manager or proof for a customer as to just how the performance testing target(s) actual perform(s) under testing.

As the user interface 10 is being manipulated by the user to modify settings, the user can press the Apply button 42 in order to have modified settings communicated back to the performance testing system and used to modify performance testing going forward. The Save button 44 may be used to apply the modifications to the projection 26 such that the XML document in which the project 26 is defined is itself modified also. The Cancel Change button 46 enables the user to reverse a change that has been applied using the Apply button 42, and the Restore Last Saved button 48 enables the user to reverse a change that has been applied to the XML document in which the project 26 is defined thereby to revert back to the just-previous settings.

During execution of the performance testing at step 300, which proceeds for the duration of the test period unless manually stopped, concurrent test sessions are repeatedly initiated according to the test parameters (step 300), and modifications to the test parameters are checked for (step 304). A performance test may continue through the entirety of the test period once executed without any requests for modifications to the test parameters. However, according to the invention, throughout the entire test period, modifications to the test parameters may be requested by a user via the user interface by using the user interface to modify a use case, remove a use case, modify the transactions per second, modify the use case proportions, and the like, and then pressing the “Apply” button. The requested modifications, if any, are made very shortly thereafter (step 306), and concurrent test sessions are subsequently repeatedly initiated according to the modified test parameters (step 308). A check is made to determine whether the test period is complete (step 310) and, in the event that the test period is not complete, the process reverts to step 304 to check again for modifications to test parameters as described above. In the event that the test period is complete, the performance testing is complete (step 320).

In this embodiment, step 302 is conducted over a period of about 5 seconds, and then steps 304, 306 and 308 and 310 are together conducted over a period of about 5 seconds. As such, throughout the test period the user has the opportunity to make various modifications to the test parameters each of which then are implemented by the performance testing system no more than 5 seconds later. For example, the user may choose to modify the transactions per second from the initial amount of 1500, up to 4000 transactions per second. Within the following 5 seconds, this request is received by the performance testing system and used to increase its rate of production of transactions so that rather than 7,500 transactions being created and scheduled to be directed to the performance test target(s) over the following 5 seconds, 20,000 transactions are created and scheduled to be sent over the following 5 seconds. Shortly thereafter the user may choose to remove a Use Case from consideration so as to determine whether a performance problem is due to a particular Use Case, or due to a high rate of transactions per second in general. It can be seen that equipping the performance testing system with the ability to receive and make modifications to the performance testing “on the fly” can provide the user with excellent flexibility in diagnosing problems, and in testing the true limits of a performance test target. In this sense, Use Cases, Scenarios, transactions per second, and other parameters may be seen as building blocks to overall diagnostics and granular limit testing as opposed to predefined rigid limitations of performance testing.

As also seen in FIG. 1, in accordance with the initial reports parameters established in step 200, during execution of performance testing the performance testing system displays live test session statistics specified by the “Watch List”(step 312). During the test period, however, the performance test system can receive requests for live reports of other subsets of live statistics about the test sessions and can automatically display the live reports that have been requested. A user can add or remove live statistics to or from the “Watch List” at any time during the test period and make the request of the performance testing system to accordingly modify the reports parameters by pressing “Apply”. In particular, requests for modifications to reports parameters are checked for (step 314) and reports parameters are modified if modifications have been requested (step 316) so that live test session statistics can be displayed according to the modified reports parameters (step 318). If the test period is not complete at step 310, then the live test session statistics process continues at step 314 to check for modifications to reports parameters.

It will be understood that, in this embodiment, steps 312 through 318 involving displays of live test session statistics are conducted in parallel (ie. at the same time) as steps 302 through 308 involving initiating test sessions, rather than one after another. These two streams of steps are managed by different threads on the performance testing system. In alternative embodiments, these sets of steps could be interleaved with one another, particularly if the rate at which each step is conducted is fast enough to ensure live statistics reflect the performance of the performance testing target in synchronization with the modifications to the performance tests that may be required.

It will also be understood that the live statistics displays and the initiating of test sessions, being parallel processes, do not require each other to be executed. For example, performance testing could proceed with modifications being made during the test period without changing the live statistics being displayed.

However, by enabling the user to view live statistics about the concurrent test sessions that are initiated and carried through, and by providing the opportunity for the user to select which of the subsets of live statistics being generated are displayed during the test period, the user can “drill down” into the diagnostics of a problem as the problem is unfolding, as well as confirm that good performance that is indicated by one subset of live statistics can be corroborated by another selected subset of live statistics.

Furthermore, by enabling modifications to both the test parameters and the reports parameters during the test period (ie. while the testing is being conducted), the user can react to live statistics reflecting the performance of the performance test target(s) in real-time by modifying test parameters in order to define the extent of a problem, its cause, and/or to corroborate and confirm a strong performance metric in multiple ways without having to stop the performance test and reconfigure another test. Having this kind of control over the performance testing and the statistical performance data being returned provides a very useful and entertaining tool for performance testing personnel, and a great deal of flexibility in generating granular performance reports and useful information to be returned to product designers, systems integrators, software developers, and the like.

As shown in FIG. 2, computing system 1000 includes a bus 1010 or other communication mechanism for communicating information, and a processor 1018 coupled with the bus 1010 for processing the information. The computing system 1000 also includes a main memory 1004, such as a random access memory (RAM) or other dynamic storage device (e.g., dynamic RAM (DRAM), static RAM (SRAM), and synchronous DRAM (SDRAM)), coupled to the bus 1010 for storing information and instructions to be executed by processor 1018. In addition, the main memory 1004 may be used for storing temporary variables, server instances, and intermediate information during the execution of instructions by the processor 1018. Processor 1018 may include memory structures such as registers for storing such temporary variables or other intermediate information during execution of instructions. The computing system 1000 further includes a read only memory (ROM) 1006 or other static storage device (e.g., programmable ROM (PROM), erasable PROM (EPROM), and electrically erasable PROM (EEPROM)) coupled to the bus 1010 for storing static information and instructions for the processor 1018.

The computing system 1000 also includes a disk controller 1008 coupled to the bus 1010 to control one or more storage devices for storing information and instructions, such as a magnetic hard disk 1022, and a removable media drive 1024 (e.g., floppy disk drive, read-only compact disc drive, read/write compact disc drive, compact disc jukebox, tape drive, and removable magneto-optical drive). The storage devices may be added to the computing system 1000 using an appropriate device interface (e.g., small computing system interface (SCSI), integrated device electronics (IDE), enhanced-IDE (E-IDE), direct memory access (DMA), or ultra-DMA).

The computing system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computing system 1000 may also include a display controller 1002 coupled to the bus 1010 to control a display 1012, such as a liquid crystal display (LCD) screen, for displaying information to a computer user. The computing system 1000 includes input devices, such as a keyboard 1014 and a pointing device 1016, for interacting with a computer user and providing information to the processor 1018. The pointing device 1016, for example, may be a mouse, a trackball, or a pointing stick for communicating direction information and command selections to the processor 1018 and for controlling cursor movement on the display 1012. In addition, a printer may provide printed listings of data stored and/or generated by the computing system 1000.

The computing system 1000 performs a portion or all of the processing steps discussed herein in response to the processor 1018 executing one or more sequences of one or more instructions contained in a memory, such as the main memory 1004. Such instructions may be read into the main memory 1004 from another computer-readable medium, such as a hard disk 1022 or a removable media drive 1024. One or more processors in a multi-processing arrangement may also be employed to execute the sequences of instructions contained in main memory 1004. In alternative embodiments, hard-wired circuitry may be used in place of or in combination with software instructions.

As stated above, the computing system 1000 includes at least one computer-readable medium or memory for holding instructions programmed according to the teachings of the invention and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer-readable media, includes software for controlling the computing system 1000, for driving a device or devices to perform the functions discussed herein, and for enabling the computing system 1000 to interact with a human user (e.g., print production personnel). Such software may include, but is not limited to, device drivers, operating systems, development tools, and applications software. Such computer-readable media further includes the computer program product for performing all or a portion (if processing is distributed) of the processing performed discussed herein.

The computer code devices of discussed herein may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A computer-readable medium providing instructions to a processor 1018 may take many forms, including but not limited to, non-volatile media, volatile media, and transmission media. Non-volatile media includes, for example, optical, magnetic disks, and magneto-optical disks, such as the hard disk 1022 or the removable media drive 1024. Volatile media includes dynamic memory, such as the main memory 1004. Transmission media includes coaxial cables, copper wire and fiber optics, including the wires that make up the bus 1010. Transmission media also may also take the form of acoustic or light waves, such as those generated during radio wave and infrared data communications.

Various forms of computer-readable media may be involved in carrying out one or more sequences of one or more instructions to processor 1018 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computing system 1000 may receive the data on the telephone line and use an infrared transmitter to convert the data to an infrared signal. An infrared detector coupled to the bus 1010 can receive the data carried in the infrared signal and place the data on the bus 1010. The bus 1010 carries the data to the main memory 1004, from which the processor 1018 retrieves and executes the instructions. The instructions received by the main memory 1004 may optionally be stored on storage device 1022 or 1024 either before or after execution by processor 1018.

The computing system 1000 also includes a communication interface 1020 coupled to the bus 1010. The communication interface 1020 provides a two-way data communication coupling to a network link that is connected to, for example, a local area network (LAN) 1500, or to another communications network 2000 such as the Internet. For example, the communication interface 1020 may be a network interface card to attach to any packet switched LAN. As another example, the communication interface 1020 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1020 sends and receives electrical, electromagnetic or optical signals that carry digital data streams representing various types of information.

The network link typically provides data communication through one or more networks to other data devices, including without limitation to enable the flow of electronic information. For example, the network link may provide a connection to another computer through a local network 1500 (e.g., a LAN) or through equipment operated by a service provider, which provides communication services through a communications network 2000. The local network 1500 and the communications network 2000 use, for example, electrical, electromagnetic, or optical signals that carry digital data streams, and the associated physical layer (e.g., CAT 5 cable, coaxial cable, optical fiber, etc). The signals through the various networks and the signals on the network link and through the communication interface 1020, which carry the digital data to and from the computing system 1000 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computing system 1000 can transmit and receive data, including program code, through the network(s) 1500 and 2000, the network link and the communication interface 1020. Moreover, the network link may provide a connection through a LAN 1500 to a mobile device 1300 such as a personal digital assistant (PDA), laptop computer, or cellular telephone.

Alternative configurations of computing system 1000, such as those having a processing structure that employs multiple processors rather than a single processor in a known manner, and/or that may be controlled remotely by another computing system and not interacted with directly by a human user through a graphical or text user interface, may be used to implement process 90.

In this embodiment, alternative data devices include performance test targets such as target servers 3000_1 to 3000_n, where n may be any integer. Each target server 3000_1 to 3000_n may have one or more interfaces 1_1 to 1_m, n_1 to n_m, respectively. Multiple performance tests may be executed by initiating performance test sessions concurrently with one ore more interfaces on each of one or more target devices, depending upon the test parameters.

FIG. 4 is a logical structure diagram showing logical components of the performance testing system that computing system 1000 has been specially configured to implement. Computing system 1000 as configured provides user interface 10 in the form of a browser-accessible Web interface, and communications between the performance testing system on computing system 1000 and the client system displaying the user interface 10 are conducted using Web Sockets and HTTP (Hyper Text Transfer Protocol) communications. Similarly, performance testing system on computing system 1000 communicates via particular SSH, SOAP (Simple Object Access Protocol), Diameter or other Target Peers 28 provided on performance testing target machines 3000_1 to 3000_n.

In FIG. 4, arrowed lines represent data flow. Letters heading the captions of the data flows identify the performance testing system's inner processes that can run in parallel. For example, A, B1→B4, C1→C6, D, E, F, G, H and it can all be functioning simultaneously.

Process A In FIG. 4, “Project Loader” 1606 will receive client's request of project importation or creation, and load the project data to the memory storage. These data include: a. “Interface Definition” 1622, which is a map of Target Peer names and their network identifications. The format of network identifications may vary for different protocols; b. “Use Case Message Flow Definition” 1614, which is the definition of scenarios, each scenario will be implemented as a sequence of “Request”/“Expected Response” transaction message and their associated interfaces. Also, some indicators may be applied to the transaction, for example, indicator ‘Sync’ demands the synchronization with the last transaction; c. “Execution Agenda” 1604, which will include the load level (namely TPS), use-case/scenario involvement (scenarios selected to run and their proportion, session duration)

Process B in FIG. 4, B1. “Execution Controller” 1602, when receiving the ‘Start’ user request will invoke “Data Initiator” 1628 to run a script on the being tested target system to initialize data for the test; B2. “Execution Controller” 1602 will forward the ‘Start’ request to “Message Flow Scheduler” 1612; B3. B3 always runs when a time windows starts. “Message Flow Scheduler” 1612 will get information from “Execution Agenda” 1604 and “Use Case Message Flow Definition” 1614; B4. “Message Flow Scheduler” 1612 schedules message transmission randomly in the following Time Windows by creating timers 1618.

Every timer will be bound with data Use Case ID, Message ID and Session ID, they are sent to “Request Dispatcher” 1620 when the timer is expired/triggered.

Session ID is generated to realize the concurrency. For example, for use-case/scenario UC1, the Session ID can be generated in the range of UC100000000 to UC199999999. Also, when encoding Message Data in C3 of process C, depending the business logic, some key fields such as Subscriber-ID should be decorated by the same digit suffix. The same rule is applied to Data Initiation as well. When the top edge of the range (99999999) is reached, it will loop back to the lowest number (00000000).

The “Message Flow Scheduler” 1612 is the key component that control the execution according to the “Execution Agenda” 1604. It functions recursively along Time Windows. Time Window is defined as a number of seconds which is configurable, when the test starts, it is on the time window 0. Every time the running test enters a new Time Window, “Message Flow Scheduler” 1612 will create timers 1618 in following Time Windows (the number of which is decided by the Max Duration of Use Cases) until the number of timers in the adjacent next Time Window reaches the required TPS.

Process C in FIG. 4, C1. When a timer is expired, the bounded data will be sent to “Request Dispatcher” 1620; C2. “Request Dispatcher” 1620 will get message detail from “Use Case Message Flow Definition” 1614 by Message ID, and further get the “Interface Definition” 1622; C3. “Request Dispatcher” 1620 will encode the message according to the protocol and send it to the target system being tested through the according Message Transmitter (1630, 1632, 1634) that is plugged in the Server side to act as the adapter for the designated interface; C4, every Request sending will be logged in “Execution Trace Records” 1616; C5. Transmitters (1630, 1632, 1634) will send the response from the target system to the “Response Verification” 1624; C6. “Response Verification” 1624 will take the Expected Response from “Use Case Message Flow Definition” 1614 and compare with the received response; C7. “Response Verification” 1624 will update “Execution Trace Records” for received response its verification.

“Response Verification” 1624 and “Execution Trace Record” 1616 are illustrated as having multiple distributions. However, the scalability can be apply to any component depending the need. Refer to 8.1 for description of the implementation.

Process D in FIG. 4, “Machine Statistics Collector” 1636 will through SSH interface run performance profiling scripts on target machines in the target system being tested. The target machines can be dynamically designated in the Watch-list from Client side. The collected profiling data will be logged in “Machine Statistics” 1626.

Process E, F in FIG. 4, “Charting Server” 1608 will get data from “Execution Trace Records” 1616 and “Machine Statistics” 1626 and feed the data to the chart components which are listening at client side and render the charts. Requested charts are designated in Watch-list at client side.

Process G, H in FIG. 4, “Notification Server” 1610 will get data from “Execution Trace Record” 1616 and “Machine Statistics” 1626. These data are considered as exceptions, such as unexpected response, too long latency, too high CPU usage etc.

Process I in FIG. 4, “Execution Controller” 1602 as a service can receive request from client to adjust “Execution Agenda” 1604 dynamically. The new agenda will start taking effect at B3. Be noticed that the network bandwidth between the server and the target system will be detected; and the average message size should be a known factor for certain test; so the limitation of the TPS will be known. User adjustment of the TPS will be limited.

In this embodiment, the performance testing system is configured using the Erlang/OTP (Open Telecom Platform) framework, which is excellent for high-concurrency processing. It was noted that 4500 transaction per second (TPS) performance tests ran comfortably on a Centos VM (virtual machine) running on a 4-core Intel i7 laptop with 8 Gigabytes of system memory and configured for performance testing as described above, and it is expected that the most basic AWS EC2 instance or a Google Cloud Platform VM instance running Ubuntu or Centos would support 1000 TPS.

Modifications may be made without departing from the spirit, purpose and scope of the invention disclosed herein.

Although embodiments have been described with reference to the drawings, those of skill in the art will appreciate that variations and modifications may be made without departing from the spirit, scope and purpose of the invention as defined by the appended claims.

1. A performance testing system comprising:
processing structure configured to execute performance testing, the performance testing comprising automatically and repeatedly initiating concurrent test sessions with at least one performance test target during a test period, the processing structure configured to receive test modification requests during the test period and, in response, to automatically modify the performance testing for the remainder of the test period.

2. The performance testing system of claim 1, wherein the processing structure is configured to automatically modify the performance testing by changing how often the test sessions are initiated.

3. The performance testing system of claim 1, wherein the processing structure is configured to automatically modify the performance testing by changing the scenarios of test sessions initiated.

4. The performance testing system of claim 1, wherein the performance testing comprises automatically and repeatedly initiating a plurality of different scenarios of test session during the test period, wherein the processing structure is configured to automatically modify the performance testing by changing the rate of the test sessions for each type of scenario is to be initiated relative to the others.

5. The performance testing system of claim 1, wherein the processing structure is configured to automatically and repeatedly initiate concurrent test sessions with the at least one performance testing target via multiple communication interfaces.

6. The performance testing system of claim 1, wherein the processing structure is configured to present a user interface for enabling a user to run the performance testing execution and to initiate the test modifications.

7. A computer-implemented method for performance testing comprising:
using the computer, executing performance testing comprising automatically and repeatedly initiating concurrent test sessions with at least one performance test target during a test period; and
using the computer, receiving test modification requests during the test period and, in response, automatically modifying the performance testing for the remainder of the test period.

8. The computer-implemented method of claim 7, further comprising:
using the computer, automatically modifying the performance testing by changing how often the test sessions are initiated.

9. The computer-implemented method of claim 7, further comprising:
using the computer, automatically modifying the performance testing by changing the scenarios of test sessions initiated.

10. The computer-implemented method of claim 7, wherein the performance testing comprises automatically and repeatedly initiating a plurality of different scenarios of test session during the test period, the method further comprising:
using the computer, automatically modifying the performance testing by changing the rate of the test sessions for each type of scenario is to be initiated relative to the others.

11. The computer-implemented method of claim 7, further comprising:
using the computer, automatically and repeatedly initiating the concurrent test sessions with the at least one performance testing target via multiple communication interfaces.

12. The computer-implemented method of claim 7, further comprising:
using the computer, presenting a user interface for enabling a user to run the performance testing execution and to initiate the test modifications.

13. A non-transitory computer-readable medium embodying a computer program executable on a computing system for conducting performance testing, the computer program comprising:
computer program code for executing performance testing comprising automatically and repeatedly initiating concurrent test sessions with at least one performance test target during a test period; and
computer program code for receiving test modification requests during the test period and, in response, automatically modifying the performance testing for the remainder of the test period.

14. The non-transitory computer-readable medium of claim 13, wherein the computer program code for automatically modifying the performance testing comprises:
computer program code for automatically modifying the performance testing by changing how often the test sessions are initiated.

15. The non-transitory computer-readable medium of claim 13, wherein the computer program code for automatically modifying the performance testing comprises:
computer program code for automatically modifying the performance testing by changing the scenarios of test sessions initiated.

16. The non-transitory computer-readable medium of claim 13, wherein the performance testing comprises automatically and repeatedly initiating a plurality of different scenarios of test session during the test period, wherein the computer program code for automatically modifying the performance testing comprises:
computer program code for automatically modifying the performance testing by changing the rate of the test sessions for each type of scenario is to be initiated relative to the others.

17. The non-transitory computer-readable medium of claim 13, wherein the computer program code comprises:
computer program code for automatically and repeatedly initiating the concurrent test sessions with the at least one performance testing target via multiple interfaces.

18. The non-transitory computer-readable medium of claim 13, wherein the computer program code comprises:
computer program code for presenting a user interface for enabling a user to run the performance testing execution and to initiate the test modifications.

19. A performance testing system comprising:
processing structure configured to execute performance testing, the performance testing comprising automatically and repeatedly initiating concurrent test sessions with at least one performance test target during a test period,
the processing structure configured to receive requests during the test period for subscribing or unsubscribing live reports of selected one or more subsets of live statistics about the test sessions and, in response, to automatically start sending the selected live reports repeatedly to the requestor during the test period or stop sending the unsubscribed live reports.

20. A computer-implemented method for performance testing comprising:
using the computer, executing performance testing comprising automatically and repeatedly initiating concurrent test sessions with at least one performance test target during a test period; and
using the computer, receiving requests during the test period for subscribing or unsubscribing live reports of selected one or more subsets of live statistics about the test sessions and, in response, to automatically start sending the selected live reports repeatedly to the requestor during the test period or stop sending the unsubscribed live reports.

21. A non-transitory computer-readable medium embodying a computer program executable on a computing system for conducting performance testing, the computer program comprising:
computer program code for executing performance testing comprising automatically and repeatedly initiating concurrent test sessions with at least one performance test target during a test period; and
computer program code for receiving requests during the test period for subscribing or unsubscribing live reports of selected one or more subsets of live statistics about the test sessions and, in response, to automatically start sending the selected live reports repeatedly to the requestor during the test period or stop sending the unsubscribed live reports.
